(19) United States
(12) Patent Application Publication
(10) Pub. No.: US 2009/0124340 A1
(43) Pub. Date: May 14, 2009

(54) METHOD OF GAMING AND A GAMING SYSTEM

(75) Inventor: Antoon Christiaan Visser, Coogee (AU)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty Limited, Lane Cove, NSW (AU)

(21) Appl. No.: 12/205,559

(22) Filed: Sep. 5, 2008

(30) Foreign Application Priority Data
Sep. 6, 2007 (AU) 2007904847

(51) Int. Cl. A63F 9/24; A63F 13/00

(52) U.S. Cl. 463/20; 463/43

(57) ABSTRACT

A method of gaming comprising: providing a plurality of games playable by a player; conducting play of one game of the plurality of games; awarding eligibility to a super feature game in response to a trigger condition being met in relation to the one game; conducting element collection play of at least one of the plurality of games during which the player attempts to collect elements for the super feature game; conducting play of the super feature game; and determining an outcome of play of the super feature game conducted after element collection play at least in part based on any elements collected during element collection play.

### RELATED APPLICATIONS

The present application is a non-provisional application, which claims priority to Australian Provisional Patent Application No. 2007904847 filed Sep. 6, 2007, which is incorporated herein by reference in its entirety.

### BACKGROUND OF THE INVENTION

1. Field of Invention

The present invention relates to a method of gaming and a gaming system.

2. Background of Invention

Traditionally electronic gaming machines such as slot machines have been programmed to offer a single game to players. More recently, with reduction in the cost of the memory and general computing advances, it has been practical to offer gaming machines where a player can choose from a plurality of different games.

Similarly there is a move towards downloadable gaming, where a player can select a game to be downloaded to a gaming machine from one of a plurality of games available via a gaming server.

The present invention relates to providing an interrelationship between a plurality of games.

### BRIEF SUMMARY OF THE INVENTION

In a first aspect, there is provided a method of gaming comprising:
providing a plurality of games playable by a player;
conducting play of one game of the plurality of games;
awarding eligibility to a super feature game in response to a trigger condition being met in relation to the one game;
conducting element collection play of at least one of the plurality of games during which the player attempts to collect elements for the super feature game;
conducting play of the super feature game; and
determining an outcome of play of the super feature game conducted after element collection play at least in part based on any elements collected during element collection play.

In an embodiment, the method comprises conducting element collection play until one or more end conditions are met.

In an embodiment, the end condition is that a fixed period of time has expired.

In an embodiment, the end condition is that a number of game rounds have been conducted.

In an embodiment, an end condition is that the player has obtained at least a minimum number of elements.

In an embodiment, the method comprises conducting element collection play in respect two or more of the plurality of games during which a player attempts to obtain at least one element from each of the games.

In an embodiment, the method comprises permitting a player to switch between games during element collection play.

In an embodiment, the elements are functions associated with symbols or symbol combinations in the games.

In an embodiment, the method comprises displaying obtained elements to the player.

In an embodiment, there are four games.

In an embodiment, conducting play or element collection play in respect of each game comprises receiving at least one player instruction and determining a game outcome based on the at least one player instruction, at least one game rule and a random number.

In an embodiment, the method comprises determining that the player has collected a minimum number of elements before conducting super feature play.

In an embodiment, the method comprises conducting the super feature game without any collected elements if the player chooses not to participate in element collection play.

In an embodiment, the method comprises conducting a normal feature game if the player chooses not to participate in element collection play.

In a second aspect, there is provided a gaming system comprising:
a display for displaying game play to a player; a game play mechanism operable by the player to input game play instructions; and
a game controller arranged to process game play instructions from the game play mechanism and to:
provide a plurality of games playable by a player;
conduct play of one game of the plurality of games;
award eligibility to a super feature game in response to a trigger condition being met in relation to the one game;
conduct element collection play of at least one of the plurality of games during which the player attempts to collect elements for the super feature game;
conduct play of the super feature game; and
determine an outcome of play of the super feature game conducted after element collection play at least in part based on any elements collected during element collection play.

In an embodiment, the game controller comprises a game selection module arranged to enable a player to make selections between the plurality of games.

In an embodiment, the game controller comprises a super feature module arranged to conduct the feature game.

In an embodiment, the super feature module is arranged to monitor what elements, if any, the player collects.

In an embodiment, the game controller is arranged conduct element collection play until one or more end conditions are met.

In an embodiment, an end condition is that a fixed period of time has expired.

In an embodiment, an end condition is that a number of game rounds have been conducted.

In an embodiment, an end condition is that the player has obtained at least a minimum number of elements.

In an embodiment, an end condition is that the player elects to discontinue element collection play.

In an embodiment, the game selection module is arranged to permit a player to switch between games during element collection play.

In an embodiment, the elements are functions associated with symbols or symbol combinations in the games.

In an embodiment, the gaming system is arranged to display obtained elements to the player.

In an embodiment, the game controller is arranged to determine that the player has collected a minimum number of elements before conducting super feature play.

In an embodiment, the game controller is arranged to conduct the super feature game without any collected elements if the player chooses not to participate in element collection play.

In an embodiment, the game controller is arranged to conduct a normal feature game if the player chooses not to participate in element collection play.

In a third aspect, there is provided a game controller for a gaming system, the game controller arranged to process game play instructions from the game play mechanism and to:
provide a plurality of games playable by a player;
conduct play of one game of the plurality of games;
award eligibility to a super feature game in response to a trigger condition being met in relation to the one game;
conduct element collection play of at least one of the plurality of games during which the player attempts to collect elements for the super feature game;
conduct play of the super feature game; and
determine an outcome of play of the super feature game conducted after element collection play at least in part based on any elements collected during element collection play.

In an embodiment, the game controller comprises a game selection module arranged to enable a player to make selections between the plurality of games.

In an embodiment, the game controller comprises a super feature module arranged to conduct the feature game.

In an embodiment, the super feature module is arranged to monitor what elements, if any, the player collects.

In an embodiment, the game controller is arranged conduct element collection play until one or more end conditions are met.

In an embodiment, the game selection module is arranged to permit a player to switch between games during element collection play.

In an embodiment, the elements are functions associated with symbols or symbol combinations in the games.

In an embodiment, the game controller is arranged to display obtained elements to the player.

In an embodiment, the game controller is arranged to determine that the player has collected a minimum number of elements before conducting super feature play.

In an embodiment, the game controller is arranged to conduct the super feature game without any collected elements if the player chooses not to participate in element collection play.

In an embodiment, the game controller is arranged to conduct a normal feature game if the player chooses not to participate in element collection play.

In an embodiment, the game controller is implemented, at least in part, by a processor executing program code from a memory.

In a fourth aspect, there is provided computer program code which when executed by a processor causes the processor to implement the above method.

In a fifth aspect, there is provided a computer readable medium comprising the computer program code.

In a sixth aspect, there is provided a data signal comprising the computer program code.

In a seventh aspect, the invention extends to transmitting the computer program code.

### BRIEF DESCRIPTION OF SEVERAL VIEWS OF THE DRAWINGS

FIG. 1 is a block diagram of the core components of a gaming system.

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a functional block diagram of further components of the gaming system in particular showing detail of the game controller.

FIG. 7 shows detail of the data stored in respect of each game;

FIG. 8 is a flow chart of the method of the embodiment;

FIG. 9 is a first exemplary display;

FIG. 10 is a second exemplary display;

FIG. 11 is a third exemplary display;

FIG. 12 is a fourth exemplary display;

FIG. 13 is a fifth exemplary display;

FIG. 14 is a sixth exemplary display;

FIG. 15 is a seventh exemplary display;

### DETAILED DESCRIPTION OF THE INVENTION

Referring to the drawings, there is shown a gaming system arranged to implement a game where a player initially plays one of a plurality of games. During, eligibility for play a “super” feature may be triggered. Before the super feature is played the player plays (or has the option to play) at least one of the plurality of games to attempt to accumulate elements that relate to the “super” feature. Thus, herein a “super” feature game is a period of play which is triggered by a trigger event where the player has, at least the option, to attempt to accumulate elements for the feature game subsequent to the trigger and prior to commencement of play of the super feature.

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

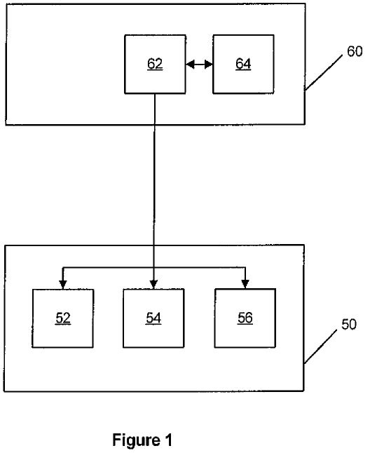

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

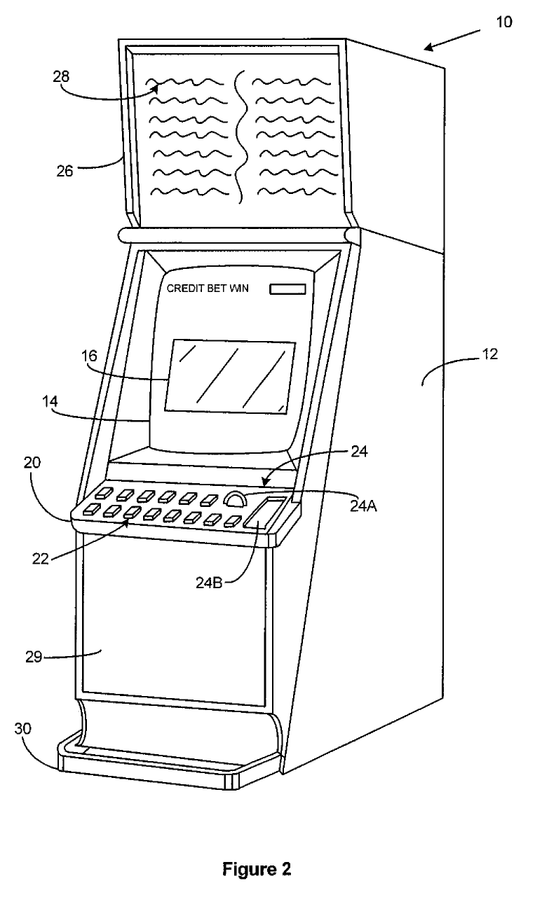

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play, The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The reading device may be provided by a player marketing module (PMM) in data communication with the gaming machine. Typically such a PMM is mounted between the console 12 and the top box 26. The player tracking device may be in the form of a magnetic stripe card a Smartcard, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube type display. Alternatively, the display 14 may be a liquid crystal display, plasma screen, any other suitable video display unit. The top box 26 may also include a display, for example a video display unit, which may be of the same type as the display 14, or of a different type.

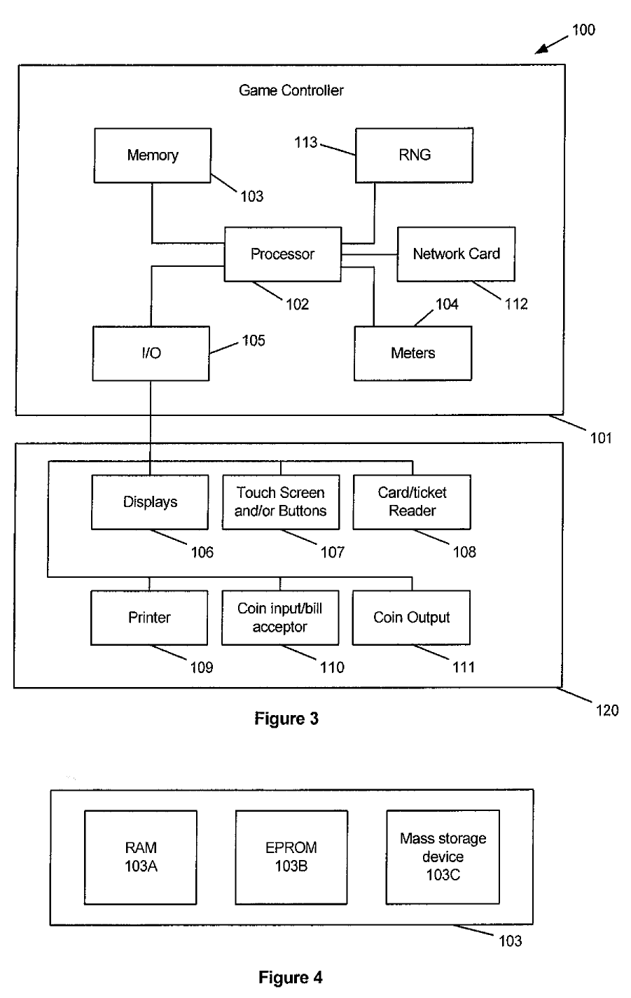

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 1030. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

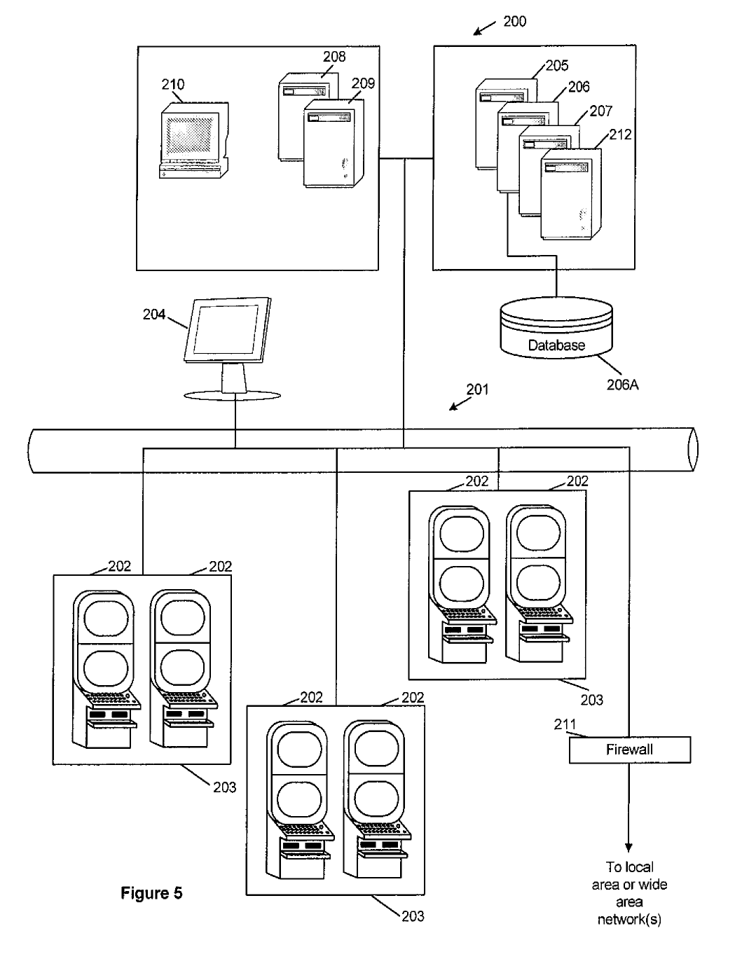

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network. The network may also incorporate a loyalty system 212.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

Accordingly, it will be appreciated that depending on the form of the invention, the plurality of games may be stored on a stand alone gaming machine or on a gaming server and served to a gaming machine as required.

The plurality of games are interrelated because any one of them may be used to trigger a super feature which involves the accumulation of elements from others of the games. While in the embodiment, each of the games, may trigger the super feature, in other embodiments only a subset of the available games may trigger the super feature. Further depending on the embodiment, the super feature may be a single feature game independent of any feature games of the individual games or a plurality of feature games, each being a variant of a normal feature game of each of the plurality of games. In other embodiments, the individual games may not have a triggered feature.

Selecting a Game

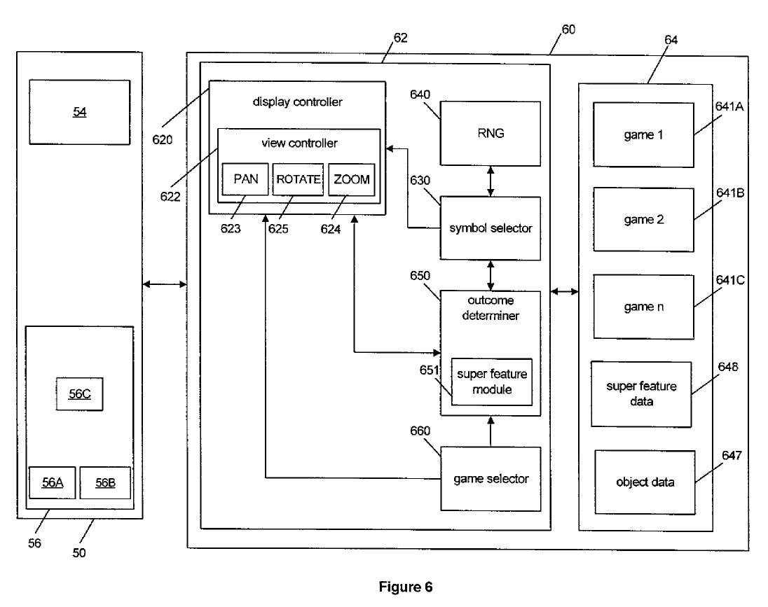

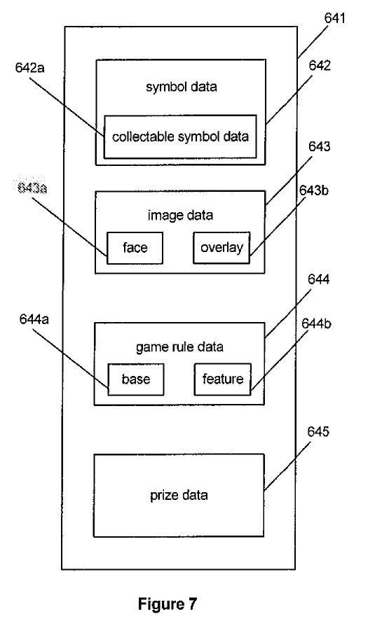

In the embodiment, the gaming system as illustrated in FIG. 6 is arranged so that the plurality of games can be displayed to a player for the player to make a selection of the game they wish to play. Accordingly, the game controller 60 incorporates a game selector 660 which is one of a series of modules 620,630,640,650,660 implemented by processor 62. The game selector 660 obtains object data 647 which defines the shape of the object to be displayed and the number of faces of the object. The game selector 660 also accesses the game data 641 for each game that is offered on the gaming machine which is stored in memory 64. The game data 641 of each game includes image data 643 including face data 643a to be displayed on the face of the object. The game selector 660 provides the face data to the display controller 620 to cause its display an object on the display 54 of the player interface 50 having a number of faces corresponding to the number of the plurality of games. The initial display can be performed in a number of different manners but in one embodiment is arranged, where there are more than two faces, such that at least two faces are initially displayed to assist the player to understand that a three dimensional object is being displayed. If there are only two faces, one face will be displayed at a time.

To select a game, the player operates the game play mechanism 56 in order to control the display of the object. Specifically, the player is able to alter the view. Accordingly, the mechanism 56 includes a view control portion 56a. The view control portion 56a is used by the player to access functions of the view controller 622 of the display controller. These functions include a pan function 623 a zoom function 624 and a rotate function 625.

Depending on the embodiment, the player's access to the functions of the view controller 622 may be limited (for example to a rotate function 625) and other functions may be carried out under control of the game selector 660. In one example, the player operates the view controls 56a to rotate the three dimensional object displayed on the display 54 to view the games that are on offer on the gaming machine. Once the player has selected a game, the game selector 660 controls the zoom function of the view controller 622 to zoom in on the face corresponding to the selected game and to add to the display an overlay based on overlay data 643b which displays to the player information required for playing the game. For example, win line data and bet amount data. When the player zooms in there is also typically an initial display set of symbols which may be the symbols of a reel, dice, balls, or the like.

The game selector also passes to the outcome determiner the game that has been selected so that the outcome determiner 650 knows which game data 641a, 641b or 641n to access to carry out the game. The outcome determiner 650 then requests the symbol selector to select symbols for the symbol data 642 using the random number generator 640 in accordance with the game rule data 644 and displays the game results by passing data to the display controller 620 to enable it to control the display 54. Game outcomes are determined based on the game rule data 644 and prize data 645.

Feature Games of Each of the Plurality of Games

In the embodiment, each of the plurality of games has its on feature game which can be triggered in addition to the super feature game. These feature games are referred to as “normal” feature games to distinguish from the super feature game. A “normal” feature is a period of play of the game triggered by a trigger event. As described above, the super feature game may be provided by variants of one or more of the individual feature games or as an independent feature.

To allow for display of the feature game, in addition to specifying the number of faces of the object, object data 647 also specifies how many levels are to be populated. In a typical embodiment the object will have two levels, a first level which is initially zoomed in on and corresponds to a base game 644a and a second level which corresponds to a feature game 644b. When the outcome determiner 650 determines that the player has qualified for the feature game, the outcome determiner 650 controls the pan function 623 of view controller 625 to pan from a first level to a second level and zoom in on the second level in order to display image data 643 corresponding to the feature game 644. The outcome determiner 650 then calculates a game outcome based on the feature rule 644b. Persons skilled in the art will appreciate that a player can qualify for the feature game by satisfying a number of trigger conditions, known in the art such as a game outcome, a bet amount, a number of games played or a random trigger.

A person skilled in the art will appreciate that in some embodiments the player may engage in further control of the view of the object. For example, the player may wish to view the feature game associated with a base game to entering a game selection input 56b. In such embodiments, the view controls 56 allow the player to access the pan 623 and zoom 624 functions. The player can pan up the object and zoom into the feature game to view the feature game.

A person skilled in the art will appreciate that a number of different objects will be suitable to displaying the multiple games. For example, if there are two games, an object such as coin having two faces can be used for the object. For three or four games a three-sided or four-sided pyramid is appropriate. A pyramid is particularly advantageous as it gives a clear indication of arising to different levels but a tapered object such as a pyramid need not necessarily be employed. In the example of a pyramid, the base may not correspond to a game. Other objects such as cubes may be appropriate, for example such that each of the six faces of a cube corresponds to a game.

A person skilled in the art will appreciate that while typically, the second level will be placed above the first level as moving upwards is more typically associated with progression. However, in some games, for example, a devil or dungeon themed game it may be appropriate for the player to descend as the progress to the second phase.

The Super Feature Game

As described above, in addition to, or instead of, triggering the normal feature a super feature may be triggered during a base game. Prior to the super feature starting, the player has an opportunity to gather elements from the other games that are available for ultimate use in the super feature game. To implement this function, the outcome determiner 650 incorporates a super feature module 651 arranged to control the super feature.

In the embodiment, each game has a collectable symbol or symbol combination 642a which is associated with a gaming function such as “doubling” symbols, sticky wild symbols, changing symbols in free games, repeating wins etc, which is characteristic of that game. In the embodiment, each game has a different function, the idea being that the player can accumulate each of the different functions to use in the super feature. In an alternative embodiment, the same function may be available from more than one game but different.

In one embodiment, the super feature is arranged such that when a normal feature is triggered during any of the base games, the player has the option to play the normal feature instantly or put it on hold and earn elements from the other games on to build a more attractive, super feature. Thus, the super feature module 651 is launched if the player selects the super feature and determines the rules that will apply to the gathering phase of the super feature from super feature data 648.

In the embodiment, if the player chooses the super feature, a period is proscribed during which the player can collect the elements. The period may be a time period, e.g. 10 minutes, but is advantageously a number of games, N. Thus, for the next N games, the player is entitled to purchase any of the plurality of games and during those games, special functionality of symbols will be collected if the symbol with the special functionality occurs during. The collected functions/symbols are displayed on the display 54 and stored in memory 648.

At the conclusion of the N games or at any time prior to that, the player can choose to start the “Super feature” by pressing a “super feature” button 56C. Depending on the embodiment, when the “super feature” button is pressed, the screen will change to display the game which the player was playing when the feature was triggered or a custom super game feature.

Images of the collected functions are animated to display the function on a symbol associated with the game in the super game and the super feature game will be played with these additional functions. The additional functions are intended to improve the player return during the “super games”. In such embodiments, the feature data 644b may specify how the functions are employed during a super feature. In an alternative embodiment which employs an independent super feature, the rules of the super feature game may be specified by super feature data 648.

In an alternative embodiment, a minimum number of special feature symbols may need to be collected in order to be eligible to activate that part of the feature.

Depending on the embodiment, the N games may need to be purchased, may be available for free or for a special bet amount—eg all lines at the minimum bet per line.

The player is able to move from game to game either using the above navigation tools or using a ‘to next game’ button and win distinctive elements from those games that will be transferred to the feature. In an alternative embodiment, the player may be automatically moved to a next game once a function has been collected or a portion of the N games have been played. For example, a fixed order of games may be defined.

In some embodiments, the duration of the period defined by the number of games N could be determined by the credits per line paid, for instance).

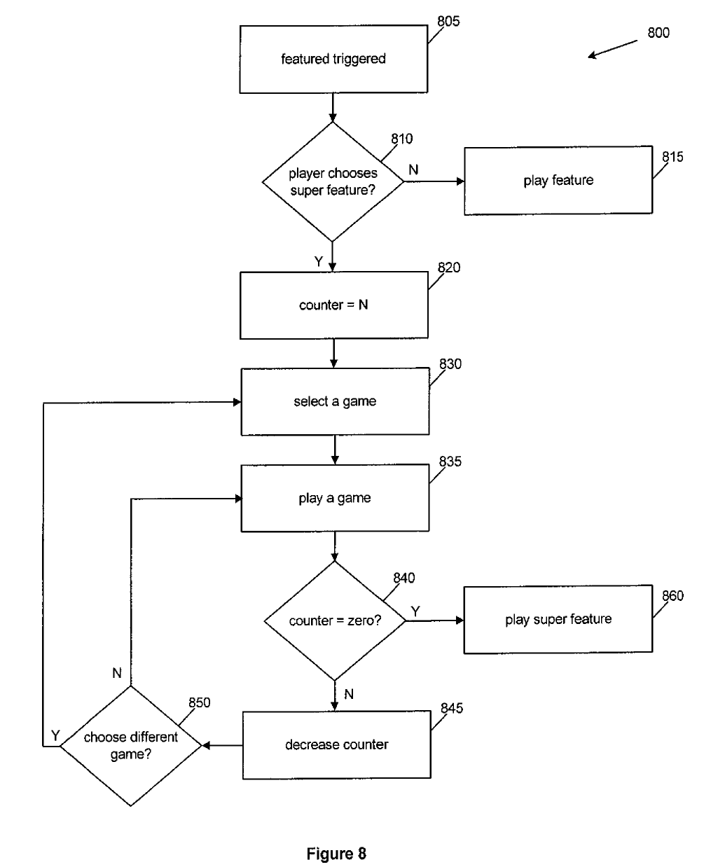

In some embodiments the elements (for instance the dragon feature from 5 dragons, a scatter from Queen of the Nile, the revealing wild from Tiki Torch Etc) transform into standardized ‘Super game feature’ symbols during display of the super feature. For example, each symbol could morph into a new symbol that is custom designed for the “Super feature”, this symbol could still display an icon of the symbol in it's original version to clarify to the player that this is one of the symbols that they have won. The method 800 is summarized in FIG. 8. After the feature is triggered 805, the player is given a choice 810 as to whether to play the super feature. If they choose not to play the super feature, they play 815 the normal feature. If they choose to play the super feature, they begin element collection play 820-850.

At the beginning of element collection play, a counter is set 820 to N, the number of game round the player has at their disposal. The player selects 830 a game from the plurality of games which may be the game that they are currently playing or another one of the games. They then play a game 835 and any symbols that appear are collected. It is then determined 840 whether the counter has reached zero. If it has not, it is decremented 845 and the player given the option to choose 850 a different game or continue with the same game. Depending on the player's choice, the player continues element collection play by selecting a game 830 or playing the previously selected game 835. When the counter reaches zero, or the player otherwise selects the super feature is to commence, the player plays 860 the super feature.

In a variation to the above embodiment, the trigger condition may be the appearance of the collectable symbol in the base game. This symbol may be collected towards either the normal feature game or the super feature game. In such an embodiment, it may also be the case that the player can only collect one symbol from each game. Thus, the player may not be able to select games from which the player has already collected a symbol during element collection play.

Various other modifications and additions will be apparent to a person skilled in the art and should be considered as falling within the scope of the invention described herein.

### EXAMPLE

A player is playing a multi-game gaming machine with the following 4 games:
1. Queen of the Nile—with a special feature of the “Queen” symbol which substitutes for all other symbols except scatters and doubles the prize.
2. Tiki Torch—with a special feature of the “Tiki” symbol which causes all the picture symbols in a game to substitute for all other symbols during free games.
3. Money Tree—with a special feature of a player choosing volatility for free games. Free games are triggered by “Bank Notes”.
4. Indian Princess—with a special feature of two scatter symbols of Taj Mahal at day or night.

The games are displayed on a 3D structure in the form of an Incan pyramid with four sides representing four different games. On all four sides there is a set of stairs on which dice roll down or appear once a game is selected. Once the dice are in place a transparent bevel or overlay appears which includes game data and the dice start to roll.

Once the feature is won, the player has the choice as to whether to take the normal feature immediately or put the feature on hold while trying to accumulate elements for the super feature.

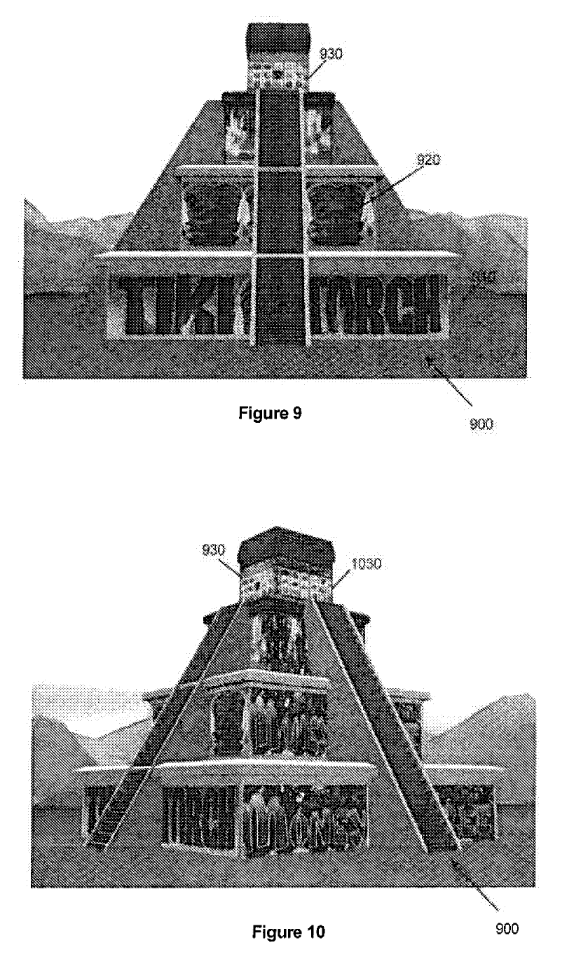

Referring to FIG. 9 there is shown a display of a pyramid where a first face 900 relates to the game “TIKI Torch” is viewable. The game is identified by a name 910 and graphics 920 that correspond to the game. The feature game for this game is viewable 930 at the top of the pyramid. Referring to FIG. 10, the pyramid has been partially rotated by a player so that a first face 900 corresponding to the game TIKI TORCH visible and a second game face 1000 corresponding to the game “Money Tree” is also visible. It can also be seen that the feature games 930, 1030 of both games are visible.

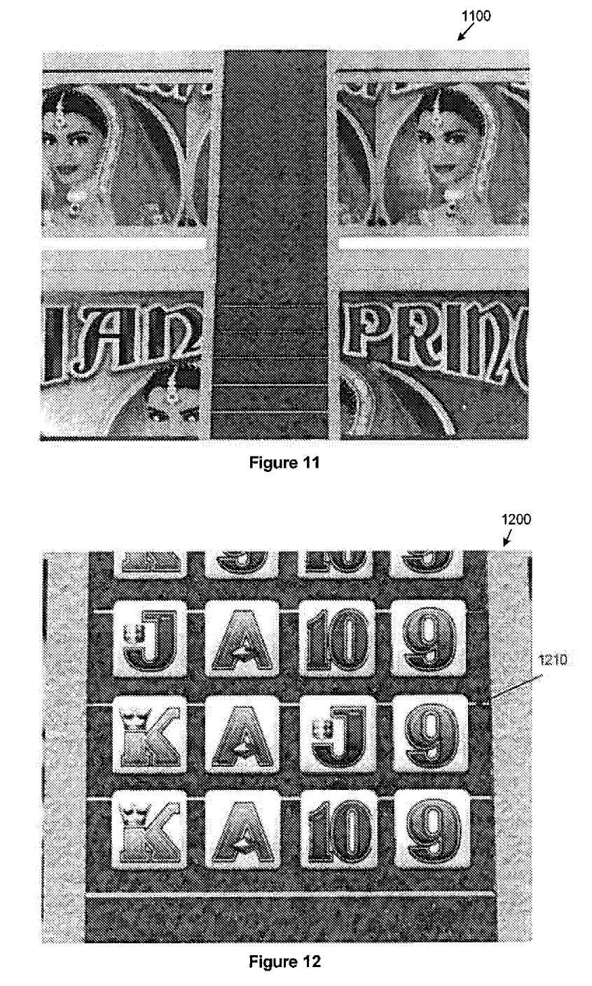

Once the player chooses a game, the camera zooms in on the pyramid. In this embodiment on the second level. FIG. 11 shows a camera that is partially zoomed in. FIG. 12 shows that after the camera is completely zoomed in, a set of dice 1210 appear on the display. FIG. 13 shows that after the dice 1210 appear, game data including a transparent overlay 1300 having information about win lines 1310, information about credits for playing the game 1320, and a credit bet and win meter 1330 is added.

In the example, the player selects to play the Queen of the Nile game and during that game, the player triggers the “super feature”.
A message is now displayed to the player with words to the effect of:
“You can now buy 10 plays to collect special symbols. During those 10 plays, you can change to any game on this machine.
Each game will enable you to collect different special symbols.
When you choose to play the “super feature”, your game will return to Queen of the Nile.
Each special symbol will transfer its special function to a symbol on the Queen of the Nile.”

The machine will display a “collection game” meter (not shown) with spaces for each of the collectable symbols.

Game Round 1

The player buys a game on the Queen of the Nile and the reels spin and the outcome shows a Queen in the window which is the collectable symbol. An image of the Queen will be collected and displayed and the game will pay any winning prizes. The count for the “collecting games” is reduced to 9.

Game Round 2

The player buys a game on the Queen of the Nile, the reel spin and the outcome is a no win and no Queen in the window. The count for the “collecting games” is reduced to 8.

Game Round 3

The player buys a game on the Queen of the Nile, the reel spin and the outcome is a no win and 2 Queens in the window. The display of collected symbols will be increase by 2 and the display will now show that 3 Queens have bee collected. The count for the “collecting games” is reduce to 7.

Game Round 4

The player changes to the Tiki Torch game.

The player buys a game on Tiki Torch, the reels spin and the outcome shows a “Tiki” in the window. The display is now updated to show the collected symbols are 3 Queens an, 1 Tiki. The count for the “collecting games” is reduced to 6.

Game Round 5

The player changes to the Indian Princess game.

The player buys a game, the reels spin and the outcome is a non win, no scatters in the window. The display remains the same. The count for the “collecting games” is reduced to 5.

Game Round 6

The player buys a game on Indian Princess, the reels spin and the outcome shows a “Taj Mahal” in the window. The display is updated to show the collected symbols are Queens, 1 Tiki and 1 Taj Mahal. The count for the “collecting games” is reduced to 4.

Game Round 7

The player changes to Money Tree.

The player buys a game, the reels spin and the outcome is a win but no “Bank Note”. The player is paid the win but the display is not updated.

The count for the “collecting games” is reduced to 3.

Game Round 8

The player buys a game in Money Tree, the reels spin and the outcome is a no win with no Bank Note. The display is not updated. The count for the “collecting games” is reduced to 2.

Game Round 9

The player buys a game in Money Tree, the reels spin and the outcome shows a bank note. The display is updated to show 3 Queens, 1 Tiki, 1 Taj Mahal and 1 Bank Note. The count for the “collecting games” is reduced to 1.

Game Round 10

The player changes to Indian Princess. The player buys a game and the reels spin and the outcome is Taj Mahal (night). The display is updated to show 3 Queens, 1 Tiki, 1 Taj Mahal, 1 Taj Mahal (night) and 1 Bank Note.

A message now appears on the screen that the player must now play the Super Games and the player presses the super feature button.

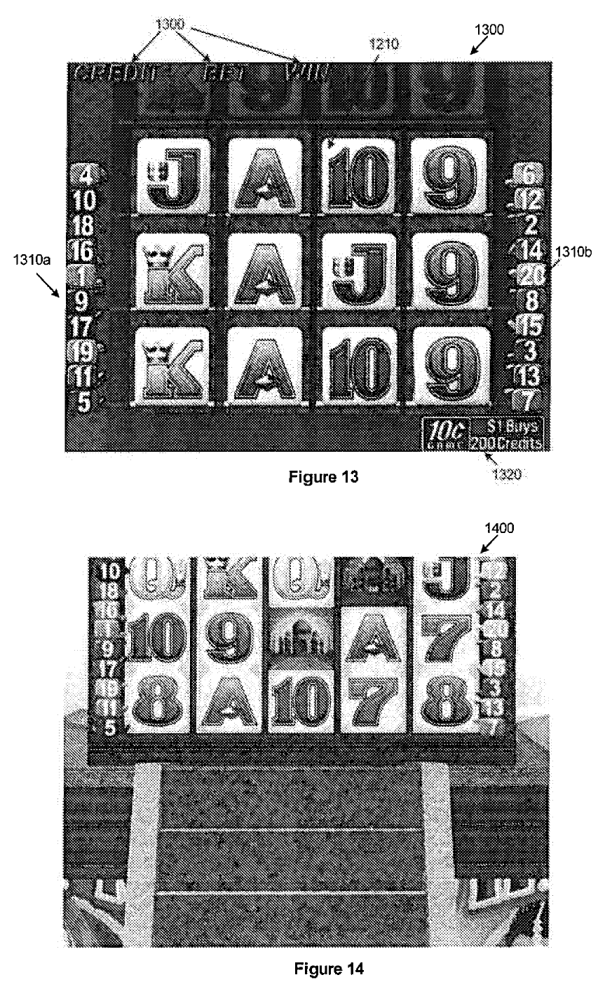

The screen changes to show the multi-game pyramid, the camera moves up the pyramid. A position half way up the pyramid is shown 1400 in FIG. 14. FIG. 15 shows that the super feature screen 1500 is displayed at the top of the pyramid. The collected special symbols from the collection stage are displayed. These symbols roll down the multi-game pyramid and an animation is played with the special symbols morphing into symbols applicable to Queen of the Nile. The Queen of the Nile super game is displayed.

In a variation, these symbols are shown in their original state, transform into their new state and fly into the “Super feature” which is located on top of the pyramid. The “camera” zooms into the top of the pyramid and the Super feature is displayed on screen.

The player now plays a sequence of “super games” with the additional special features.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
providing a plurality of games playable by a player;
conducting play of one game of the plurality of games;
awarding eligibility to a super feature game in response to a trigger condition being met in relation to the one game;
conducting element collection play of at least one of the plurality of games during which the player attempts to collect elements for the super feature game;
conducting play of the super feature game; and
determining an outcome of play of the super feature game conducted after element collection play at least in part based on any elements collected during element collection play.

2. A method as claimed in claim 1, comprising conducting element collection play until one or more end conditions are met.

3. A method as claimed in claim 2, wherein the end condition is that a fixed period of time has expired.

4. A method as claimed in claim 2, wherein the end condition is that a number of game rounds have been conducted.

5. A method as claimed in claim 2, wherein an end condition is that the player has obtained at least a minimum number of elements.

6. A method as claimed in claim 1 comprising conducting element collection play in respect two or more of the plurality of games during which a player attempts to obtain at least one element from each of the games.

7. A method as claimed in claim 6 comprising permitting a player to switch between games during element collection play.

8. A method as claimed in claim 1 wherein the elements are functions associated with symbols or symbol combinations in the games.

9. A method as claimed in claim 1 comprising displaying obtained elements to the player.

10. A method as claimed in claim 1, wherein there are four games.

11. A method as claimed in claim 1, wherein conducting play or element collection play in respect of each game comprises receiving at least one player instruction and determining a game outcome based on the at least one player instruction, at least one game rule and a random number.

12. A method as claimed in claim 1, comprising determining that the player has collected a minimum number of elements before conducting super feature play.

13. A method as claimed in claim 1, comprising conducting the super feature game without any collected elements if the player chooses not to participate in element collection play.

14. A method as claimed in claim 1, comprising conducting a normal feature game if the player chooses not to participate in element collection play.

15. A gaming system comprising:
a display for displaying game play to a player; a game play mechanism operable by the player to input game play instructions; and
a game controller arranged to process game play instructions from the game play mechanism and to:
provide a plurality of games playable by a player;
conduct play of one game of the plurality of games;
award eligibility to a super feature game in response to a trigger condition being met in relation to the one game;
conduct element collection play of at least one of the plurality of games during which the player attempts to collect elements for the super feature game;
conduct play of the super feature game; and
determine an outcome of play of the super feature game conducted after element collection play at least in part based on any elements collected during element collection play.

16. A gaming system as claimed in claim 15 wherein the game controller comprises a game selection module arranged to enable a player to make selections between the plurality of games.

17. A gaming system as claimed in claim 12 or claim 13 wherein the game controller comprises a super feature module arranged to conduct the feature game.

18. A gaming system as claimed in claim 17 wherein the super feature module is arranged to monitor what elements, if any, the player collects.

19. A gaming system as claimed in claim 15, wherein the game controller is arranged conduct element collection play until one or more end conditions are met.

20. A gaming system as claimed in claim 19, wherein an end condition is that a fixed period of time has expired.

21. A gaming system as claimed in claim 19, wherein an end condition is that a number of game rounds have been conducted.

22. A gaming system as claimed in claim 19, wherein an end condition is that the player has obtained at least a minimum number of elements.

23. A gaming system as claimed in claim 15, wherein an end condition is that the player elects to discontinue element collection play.

24. A gaming system as claimed in claim 16, wherein the game selection module is arranged to permit a player to switch between games during element collection play.

25. A gaming system as claimed in claim 15, wherein the elements are functions associated with symbols or symbol combinations in the games.

26. A gaming system as claimed in claim 15, arranged to display obtained elements to the player.

27. A gaming system as claimed in claim 15, wherein the game controller is arranged to determine that the player has collected a minimum number of elements before conducting super feature play.

28. A gaming system as claimed in claim 15, wherein the game controller is arranged to conduct the super feature game without any collected elements if the player chooses not to participate in element collection play.

29. A gaming system as claimed in claim 15, wherein the game controller is arranged to conduct a normal feature game if the player chooses not to participate in element collection play.

30. A game controller for a gaming system, the game controller arranged to process game play instructions from the game play mechanism and to:
provide a plurality of games playable by a player;
conduct play of one game of the plurality of games;
award eligibility to a super feature game in response to a trigger condition being met in relation to the one game;
conduct element collection play of at least one of the plurality of games during which the player attempts to collect elements for the super feature game;
conduct play of the super feature game; and
determine an outcome of play of the super feature game conducted after element collection play at least in part based on any elements collected during element collection play.

31. A game controller as claimed in claim 30, comprising a game selection module arranged to enable a player to make selections between the plurality of games.

32. A game controller as claimed in claim 12 or claim 13, comprising a super feature module arranged to conduct the feature game.

33. A game controller as claimed in claim 32, wherein the super feature module is arranged to monitor what elements, if any, the player collects.

34. A game controller as claimed in claim 30, wherein the game controller is arranged conduct element collection play until one or more end conditions are met.

35. A game controller as claimed in claim 31, wherein the game selection module is arranged to permit a player to switch between games during element collection play.

36. A game controller as claimed in claim 30, wherein the elements are functions associated with symbols or symbol combinations in the games.

37. A game controller as claimed in claim 30, arranged to display obtained elements to the player.

38. A game controller as claimed in claim 30, wherein the game controller is arranged to determine that the player has collected a minimum number of elements before conducting super feature play.

39. A game controller as claimed in claim 30, wherein the game controller is arranged to conduct the super feature game without any collected elements if the player chooses not to participate in element collection play.

40. A game controller as claimed in claim 30, wherein the game controller is arranged to conduct a normal feature game if the player chooses not to participate in element collection play.

41. A game controller as claimed in claim 30, implemented, at least in part, by a processor executing program code from a memory.

42. Computer program code which when executed by a processor causes the processor to implement the method of claim 1.

43. A computer readable medium comprising the computer program code of claim 42.

44. A data signal comprising the computer program code of claim 42.

45. Transmitting the computer program code of claim 42.
